(19) United States
(12) Patent Application Publication
(10) Pub. No.: US 2026/0266218 A1
(43) Pub. Date: Sep. 10, 2026

(54) CYCLONIC SEPARATOR SYSTEM

(71) Applicant: General Electric Company, Evendale, OH (US)

(72) Inventors: David Raju Yamarthi, Bengaluru (IN); Rajesh Kumar, Bengaluru (IN); Ravindra Shankar Ganiger, Bengaluru (IN); Jonathan Russell Ratzlaff, Loveland, OH (US)

(21) Appl. No.: 19/070,624

(22) Filed: Mar. 5, 2025

(51) Int. Cl. F02C 7/05; B04C 3/02; B04C 3/06; F02C 7/18

(52) U.S. Cl. CPC F02C 7/05; B04C 3/02; B04C 3/06; F02C 7/18

(57) ABSTRACT

A cyclonic separator system for a gas turbine engine includes a steam line fluidly connected to a steam source, an air line, an exhaust line, and a cyclonic separator fluidly connected to the steam line and the air line. The cyclonic separator includes a mixing chamber downstream of the steam line and the air line, a swirler downstream of the mixing chamber, and a separation chamber downstream of the swirler, the separation chamber including a first outlet and a second outlet. The first outlet of the separation chamber is fluidly connected to the exhaust line. The second outlet of the separation chamber is fluidly connected to a component of the gas turbine engine.

### FIELD

The present disclosure relates to a cyclonic separator system for a gas turbine engine.

### BACKGROUND

Turbine engines, and particularly gas or combustion turbine engines, are rotary engines that extract energy from a flow of combusted gases passing through the engine onto a plurality of turbine blades. Gas turbine engines have been used for land and nautical locomotion and power generation, but are most commonly used for aeronautical applications such as for aircraft. In aircraft, gas turbine engines are used for propulsion of the aircraft. In terrestrial applications, turbine engines are often used for power generation.

Gas turbine engines for aircraft are designed to operate at high temperatures to maximize engine efficiency, so cooling of certain engine components, such as the high pressure turbine and the low pressure turbine, can be necessary. Typically, cooling is accomplished by ducting cooler air from the high and/or low pressure compressors to the engine components that require cooling. While the compressor air is provided at a high temperature, it is cooler relative to the turbine air, and can be used to cool the turbine. When cooling the turbines, cooling air can be supplied to various turbine components, including the interior of the turbine blades and the turbine shroud.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic view of a gas turbine engine according to the present disclosure.

FIG. 2 is a schematic view of a cyclonic separator system.

FIG. 3 is a schematic view of another cyclonic separator system.

FIG. 4 is a schematic view of a cyclonic separator system with a premixer.

FIG. 5 is a schematic view of another cyclonic separator system with a premixer.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

A “line” is a pipe, a tube, or other conduit that communicates a fluid, such as air, steam, or exhaust gasses.

The present disclosure is generally related to removal of particulate matter from air flows in a gas turbine engine. Air flowing through the engine for cooling various components of the gas turbine engine may accumulate particulate matter. The particulate matter, such as dirt, dust, sand, ash, and other environmental contaminants in the cooling air can cause a loss of cooling and reduced operational time for the aircraft environment. Particles supplied to the turbine components can clog, obstruct, or coat the flow passages and surfaces of the components, which can reduce the lifespan of the components.

To reduce the amount of particulate matter in the cooling air flows, a cyclonic separator swirls steam and air in cyclic motion, applying centrifugal force on the particulate matter. The centrifugal forces push the particulates to a radial edge of the cyclonic separator, and a particle separator inhibits movement of the particulate matter back into the swirled air flow. Introducing steam to the cooling air reduces the temperature of the steam, which condenses onto the particulates. The increased mass of the particulates with a layer of water from the condensed steam improves movement of the particles toward the radial edge. An exhaust flow removes the particulate matter from the cyclonic separator, and the swirled air flow exits the cyclonic separator to cool the components of the gas turbine engine.

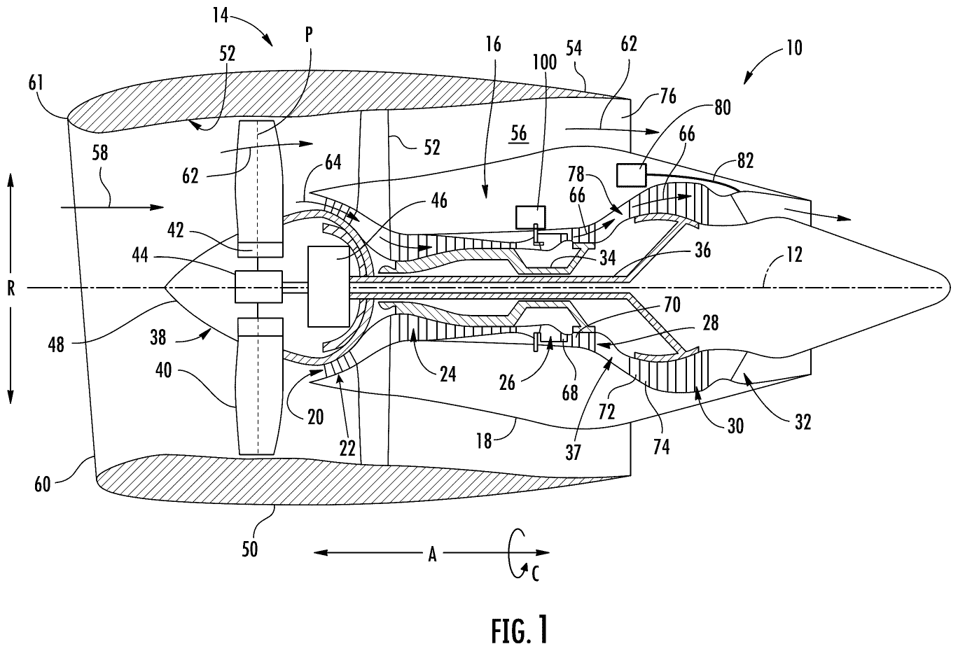

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine, sometimes also referred to as a “turbofan engine.” As shown in FIG. 1, the gas turbine engine 10 defines an axial direction A (extending parallel to a longitudinal centerline 12 provided for reference), a radial direction R, and a circumferential direction C extending about the longitudinal centerline 12. In general, the gas turbine engine 10 includes a fan section 14 and a turbomachine 16 disposed downstream from the fan section 14.

The exemplary turbomachine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24, a combustion section 26, a turbine section including a high pressure (HP) turbine 28 and a low pressure (LP) turbine 30, and an exhaust 32. A high pressure (HP) shaft 34 (which may additionally or alternatively be a spool) drivingly connects the HP turbine 28 to the HP compressor 24. A low pressure (LP) shaft 36 (which may additionally or alternatively be a spool) drivingly connects the LP turbine 30 to the LP compressor 22. The compressor section, combustion section 26, turbine section, and exhaust 32 together define a working gas flowpath 37.

For the embodiment depicted, the fan section 14 includes a fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable pitch change mechanism 44 configured to collectively vary the pitch of the fan blades 40, e.g., in unison. The gas turbine engine 10 further includes a power gear box 46, and the fan blades 40, disk 42, and pitch change mechanism 44 are together rotatable about the longitudinal centerline 12 by LP shaft 36 across the power gear box 46. The power gear box 46 includes a plurality of gears for adjusting a rotational speed of the fan 38 relative to a rotational speed of the LP shaft 36, such that the fan 38 may rotate at a more efficient fan speed.

Referring still to the exemplary embodiment of FIG. 1, the disk 42 is covered by rotatable front hub 48 of the fan section 14 (sometimes also referred to as a “spinner”). The front hub 48 aerodynamically contoured to promote an airflow through the plurality of fan blades 40.

Additionally, the exemplary fan section 14 includes an annular fan casing or outer nacelle 50 that circumferentially surrounds the fan 38 and/or at least a portion of the turbomachine 16. It should be appreciated that the nacelle 50 is supported relative to the turbomachine 16 by a plurality of circumferentially-spaced outlet guide vanes 52 in the embodiment depicted. Moreover, a downstream section 54 of the nacelle 50 extends over an outer portion of the turbomachine 16 so as to define a bypass airflow passage 56 therebetween.

During operation of the gas turbine engine 10, a volume of air 58 enters the gas turbine engine 10 through an associated inlet 60 of the nacelle 50 and fan section 14. As the volume of air 58 passes across the fan blades 40, a first portion of air 62 is directed or routed into the bypass airflow passage 56 and a second portion of air 64 (as indicated by an arrow) is directed or routed into the working gas flowpath 37, or more specifically, into the LP compressor 22. The ratio between the first portion of air 62 and the second portion of air 64 is commonly known as a bypass ratio. A pressure of the second portion of air 64 is increased as it is routed through the HP compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft 34, thus causing the HP shaft 34 to rotate, thereby supporting operation of the HP compressor 24. The combustion gases 66 are routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus causing the LP shaft 36 to rotate, thereby supporting operation of the LP compressor 22 and/or rotation of the fan 38. Collectively, a “turbine blade” may refer to one of the HP turbine stator vanes 68, the HP turbine rotor blades 70, the LP turbine stator vanes 72, or the LP turbine rotor blades 74.

The combustion gases 66 are subsequently routed through the exhaust 32 of the turbomachine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the gas turbine engine 10, also providing propulsive thrust. The HP turbine 28, the LP turbine 30, and the exhaust 32 at least partially define a hot gas path 78 for routing the combustion gases 66 through the turbomachine 16.

The gas turbine engine 10 includes a steam source 80. The steam source 80 is a device that generates steam from stored liquid water and a heat source, such as exhaust gases from the exhaust 32. More specifically, the steam source 80 receives hot gases from the exhaust 32 via an exhaust gas path 82, which heat the liquid water stored in the steam source 80 to form steam. The gas turbine engine 10 may use the steam generated by the steam source 80 for certain operations, such as particulate separation of cooling air described below.

It should be appreciated, however, that the exemplary gas turbine engine 10 depicted in FIG. 1 is by way of example only, and that in other exemplary embodiments, the gas turbine engine 10 may have any other suitable configuration. For example, although the gas turbine engine 10 depicted is configured as a ducted gas turbine engine (e.g., including the outer nacelle 50), in other embodiments, the gas turbine engine 10 may be an unducted gas turbine engine (such that the fan 38 is an unducted fan, and the outlet guide vanes 52 are cantilevered from the outer casing 18).

Additionally, or alternatively, although the gas turbine engine 10 depicted is configured as a geared gas turbine engine (e.g., including the power gear box 46) and a variable pitch gas turbine engine (e.g., including a fan 38 configured as a variable pitch fan), in other embodiments, the gas turbine engine 10 may additionally or alternatively be configured as a direct drive gas turbine engine (such that the LP shaft 36 rotates at the same speed as the fan 38), as a fixed pitch gas turbine engine (such that the fan 38 includes fan blades 40 that are not rotatable about a pitch axis P), or both. It should also be appreciated, that in still other exemplary embodiments, aspects of the present disclosure may be incorporated into any other suitable gas turbine engine. For example, in other exemplary embodiments, aspects of the present disclosure may (as appropriate) be incorporated into, e.g., a turboprop gas turbine engine, a turboshaft gas turbine engine, or a turbojet gas turbine engine.

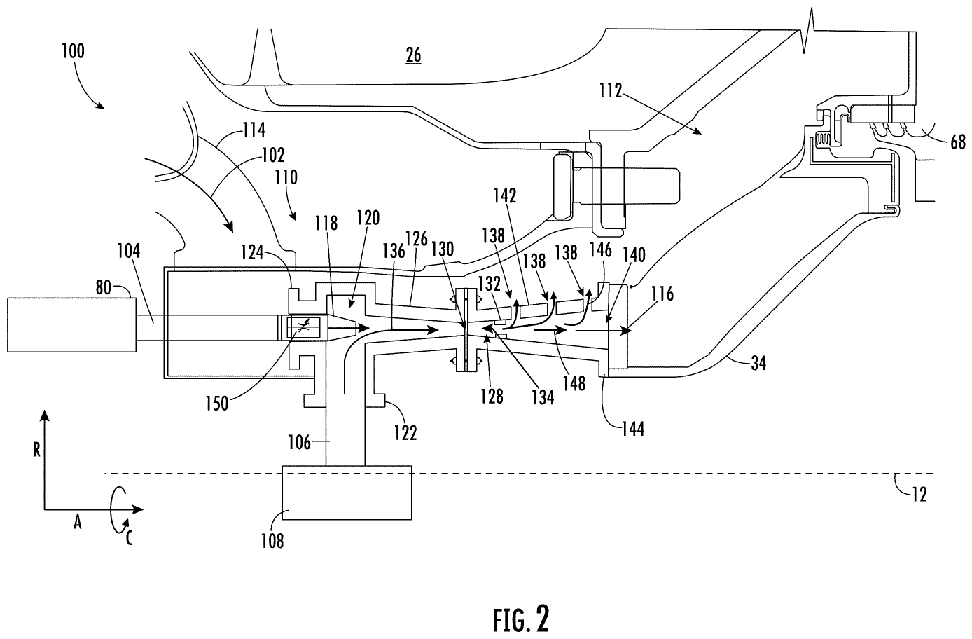

Now referring to FIG. 2, the gas turbine engine 10 includes a cyclonic separator system 100. The cyclonic separator system 100 removes particulates (such as dust, soot, and other debris) from cooling air 102 for use in cooling other components of the gas turbine engine. Referring back to FIG. 1, the cyclonic separator system 100 is disposed between the compressor section and the turbine section.

As shown in FIG. 2, the cyclonic separator system 100 includes a steam line 104 in communication with a steam source 80, an air line 106 in communication with an air source 108, a cyclonic separator 110, and an exhaust line 112 in communication with an exhaust 32. In the exemplary embodiment of FIG. 2, the cyclonic separator 110 receives cooling air 102 from a cooling circuit 114, steam from the steam line 104, and air from the air line 106 to form an air mixture. The cyclonic separator 110 swirls the air mixture, causing the particulates to move via centrifugal forces outward to the exhaust line 112, leaving clean air 116 to flow to a component, such as a turbine blade (e.g., one of the HP turbine stator vanes 68, the HP turbine rotor blades 70, the LP turbine stator vanes 72, or the LP turbine rotor blades 74). That is, the cyclonic separator 110 is disposed upstream of the HP turbine 28 and the LP turbine 30 to provide the clean air 116 to the turbine blade.

The steam line 104 provides steam from the steam source 80 to the cyclonic separator 110. In particular, a steam injector 118 may be disposed between the steam line 104 and the cyclonic separator 110 to urge steam from the steam source 80. As described above, the steam source 80 may generate steam, and the steam injector 118 provides the steam to the cyclonic separator 110. The steam line 104 is any suitable fluid line that is located to provide steam from the steam source 80.

The air line 106 provides air from the air source 108 to the cyclonic separator 110. The air source 108 may be any suitable source of air that is upstream of the compressor section, such as the volume of air 58 at the inlet 60. In particular, the air source 108 may include a pump (not shown) that draws air from the inlet 60 to the air line 106. The air line 106 is any suitable fluid line that is located to provide air from the air source 108.

The exhaust line 112 removes the particulates from the cyclonic separator 110 to the exhaust 32. Specifically, the exhaust line 112 is disposed outward of the cyclonic separator 110 to drive air with the particulates away from the cyclonic separator 110 and the clean air 116 flowing toward the turbine blade. The exhaust line 112 is any suitable fluid line that is located to transmit the particles from the cyclonic separator to the exhaust 32.

The cyclonic separator 110 is an eductor fluidly connected to the steam line 104 and the air line 106. The cyclonic separator 110 includes a mixing chamber 120 including a radial inlet 122 and an axial inlet 124, a converging nozzle 126, a diffuser 128, a throat 130 connecting the converging nozzle 126 to the diffuser 128, a swirler 132, and a separation chamber 134. The axial inlet 124 acts a “motive” inlet of the eductor, and the radial inlet 122 acts as a “suction” inlet of the eductor. That is, a motive fluid flowing through the motive inlet causes pressure to decrease in the suction inlet, driving a suction fluid through the suction inlet. In such a form, the motive inlet causes suction fluid flow through the suction inlet and mixing of the motive and suction fluids in the eductor.

The radial inlet 122 and the axial inlet 124 each receive at least one of the steam line 104 or the air line 106. In particular, in FIG. 2, the steam line 104 and the cooling air 102 are provided to the axial inlet 124, and the air line 106 is provided to the radial inlet 122. The steam line 104 and the cooling air 102 drive the air from the air line 106 provided to the radial inlet 122 to the mixing chamber 120, forming an air mixture 136. In such a form, the momentum from the steam and the cooling air 102 in the axial inlet 124 causes a pressure decrease in the air in the radial inlet 122, causing additional air to flow from the air line 106.

The air mixture 136 moves from the mixing chamber 120 toward the converging nozzle 126, which tapers inward toward the throat such that the air mixture is compressed in the converging nozzle 126. The compression lowers the pressure of the air mixture 136 while increasing the speed of the air mixture 136.

The diffuser 128 tapers outward from the throat 130 such that, as the air mixture 136 passes through the throat 130 into the diffuser 128, the air mixture 136 expands. During the expansion, the speed of the air mixture 136 drops while the pressure of the air mixture 136 increases. The change in speed and pressure, known as the “Venturi effect,” increases mixing of the air mixture 136.

The swirler 132 is disposed downstream of the throat 130 to swirl the air mixture 136. In particular, the swirler 132 is shaped to drive the air mixture 136 circumferentially along the diffuser 128, which causes the particulates in the air mixture 136 to move outward by centrifugal forces. Example shapes of the swirler 132 may include, but are not limited to, circular shapes, flat angled shapes, elliptical shapes, logarithmic shapes, or combinations thereof. The swirler 132 extends circumferentially around the diffuser 128 as a 360 degree, continuous structure. Alternatively, not shown in the FIGS., the swirler 132 may include a plurality of discrete parts arranged circumferentially around the diffuser 128.

The separation chamber 134 is disposed downstream of the swirler 132 and separates the particulates from the air mixture 136. Specifically, the separation chamber 134 includes a first outlet 138 fluidly connected to the exhaust line 112 and a second outlet 140 fluidly connected to a component of the gas turbine engine 10, such as the turbine blade. The first outlet 138 is disposed on a radial portion 142 of the separation chamber 134, and the second outlet 140 is disposed on an axial portion 144 of the separation chamber 134. The centrifugal motion of the air mixture 136 in the separation chamber 134 causes the air mixture 136 to separate into a first flow 146 and a second flow 148. The first flow 146 moves through the first outlet 138 to the exhaust line 112 (and to the exhaust 32), and the second flow 148 moves through the second outlet 140 to the component as the clean air 116. Because the particulates move outward to the radial portion 142 of the separation chamber 134, the first flow 146 includes more particulates than the second flow 148. It will be appreciated that the first outlet 138 may include a plurality of holes or voids, such as the three holes shown in FIG. 2, to drive the first flow 146 into the exhaust line 112.

The cyclonic separator system 100 may include a throttle 150 disposed between the steam line 104 and the mixing chamber 120. The throttle 150 is a structure, such as a valve, that is actuatable from a fully open position and a fully closed position and one or more positions between the open position and the closed position to allow none, some or all of a fluid flow to flow from the steam line 104 to the mixing chamber 120. The throttle 150 is actuatable to allow a specified amount of steam from the steam line 104 into the cyclonic separator 110. Specifically, the throttle 150 may be connected to a controller (not shown) that opens the throttle 150 to a specific position, which allows flow of a specified amount of the steam from the steam line 104. Alternatively, not shown in FIG. 2, the cyclonic separator system 100 may not include the throttle 150, and all steam from the steam line 104 flows into the cyclonic separator 110.

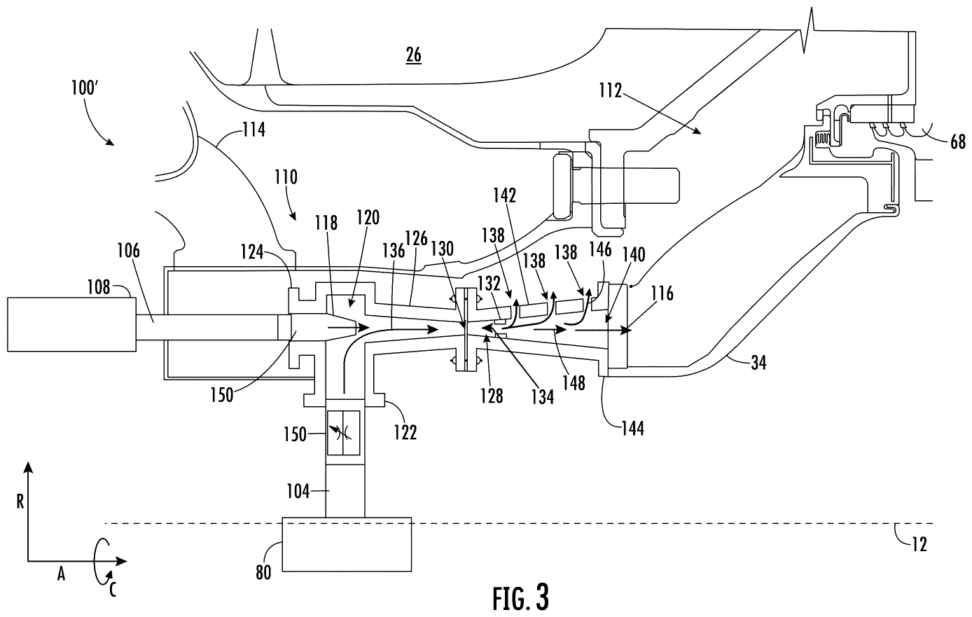

With reference to FIG. 3, a schematic view of another cyclonic separator system 100′ is provided. It will be appreciated that components that are similar between FIGS. 2-3 will share a common numeral. In particular, the cyclonic separator system 100′ of FIG. 3 differs from the cyclonic separator system 100 of FIG. 2 only in that the air line 106 is fluidly connected to the radial inlet 122 and the steam line 104 is fluidly connected to the axial inlet 124. That is, the air from the air source 108 acts as the motive fluid for the cooling air 102, and the steam from the steam source 80 acts as the suction fluid. The cyclonic separator system 100′ of FIG. 3 is shown with a throttle 150 disposed between the steam line 104 and the mixing chamber 120, and it will be appreciated that the throttle 150 may be omitted. By using air as the motive fluid and steam as the suction fluid, the steam swirls the air mixture 136 in the mixing chamber 120, which begins separating the particulates from the air mixture 136 to form the clean air 116.

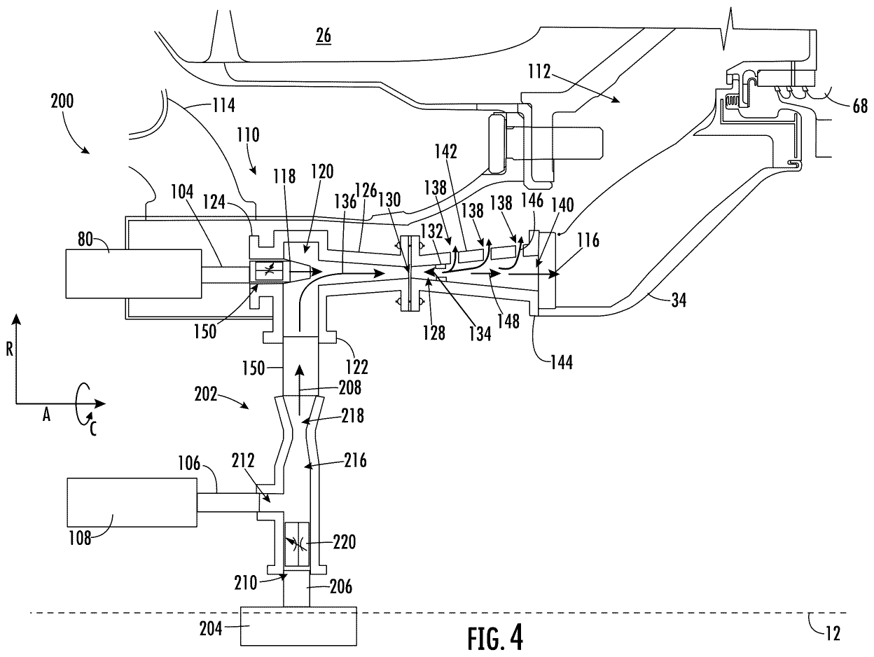

Now referring to FIG. 4, a schematic view of a cyclonic separator system 200 is provided. As with the cyclonic separator system 100 of FIG. 2, the steam source 80 is connected to the axial inlet 124 of the mixing chamber 120 to act as the motive fluid, and the air source 108 provides air to the radial inlet 122 of the mixing chamber 120.

The cyclonic separator system 200 includes a premixer 202 fluidly connected to the radial inlet 122 of the mixing chamber 120 and a cold air source 204 fluidly connected to the premixer 202 via a cold air line 206. The premixer 202 mixes air from the air source 108 and cold air from the cold air source 204 to form a premixture 208 that flow into the radial inlet 122 of the mixing chamber 120. In this context, “cold” air is air that is colder than the air from the air source 108, and examples of cold air include, but are not limited to, a bleed from the HP compressor 24 or a bleed from the LP compressor 22..

The premixer 202 includes a first inlet 210, a second inlet 212, an outlet 214, a premixing chamber 216, and a diffuser 218 connecting the premixing chamber 216 to the outlet 214. The cold air line 206 is fluidly connected to the first inlet 210, and the air line 106 is fluidly connected to the second inlet 212. Air from the air line 106 and cold air from the cold air line 206 mix in the premixing chamber 216 to form the premixture 208. In such a form, the premixture 208 has a lower temperature than the air from the air line 106, which improves condensation of the steam onto the particulates of the cooling air 102. As with the diffuser 128 of the cyclonic separator 110, the diffuser 218 of the premixer 202 improves mixing of the premixture 208 by the Venturi effect.

The cyclonic separator system 200 may a first throttle 150 downstream of the steam line 104 and a second throttle 220 downstream of the cold air line 206. As described above, the first throttle 150 controls an amount of steam introduced to the mixing chamber 120. The second throttle 220 controls an amount of cold air from the cold air line 206 introduced to the premixing chamber 216. In such a form, the amount of the cold air is specified to control the temperature of the premixture 208. Alternatively, one or both of the first throttle 150 and the second throttle 220 may be omitted from the cyclonic separator system 200.

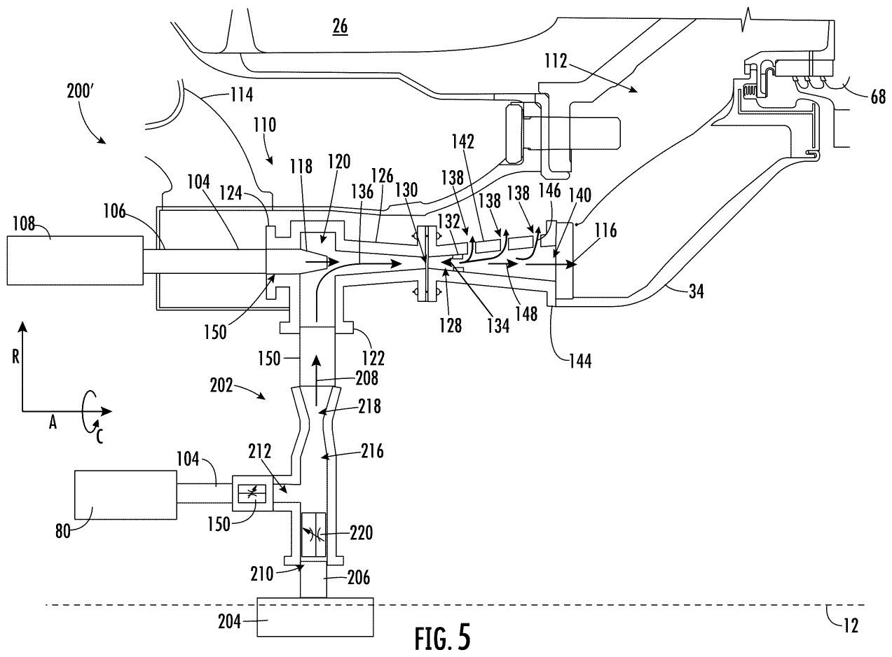

Now referring to FIG. 5, a schematic view of a cyclonic separator system 200′ is provided. In particular, the air source 108 is fluidly connected to the axial inlet 124 of the mixing chamber 120 of the cyclonic separator 110 with the air line 106, the cold air source 204 is fluidly connected to the first inlet 210 of the premixer 202 with the cold air line 206, and the steam source 80 is fluidly connected to the second inlet 212 of the premixer 202 with the steam line 104. In such a form, a premixture 208 of the cold air and the steam is formed in the premixing chamber 216, lowering the temperature of the steam before introduction to the cyclonic separator 110. The amount of the cold air and the steam in the premixture 208 may be specified such that the premixture 208 has a specified temperature, and the premixture 208 may include water condensed from the steam. The lower temperature improves condensation of the steam in the premixture 208 onto the particulates of the cooling air 102, which improves removal of the particulates to the exhaust line 112.

By using a cyclonic separator and a steam source, centrifugal forces from a swirled flow push the particulates to a radial edge of the cyclonic separator, where the particulates are removed to an exhaust. The condensed steam on the particulates improves movement of the particles away from the center of the cyclonic separator. Controlling the temperature of the steam with a cold air source further increases condensation and particulate removal. The remaining clean air may be used for cooling components, such as turbine blades.

Further aspects are provided by the subject matter of the following clauses:

A cyclonic separator system for a gas turbine engine, the cyclonic separator system including a steam line fluidly connected to a steam source, an air line, an exhaust line, and a cyclonic separator fluidly connected to the steam line and the air line, the cyclonic separator including a mixing chamber downstream of the steam line and the air line, a swirler downstream of the mixing chamber, and a separation chamber downstream of the swirler, the separation chamber including a first outlet and a second outlet, wherein the first outlet of the separation chamber is fluidly connected to the exhaust line, and wherein the second outlet of the separation chamber is fluidly connected to a component of the gas turbine engine.

The cyclonic separator system of any of the preceding clauses, wherein the cyclonic separator further includes a premixing chamber upstream of the mixing chamber.

The cyclonic separator system of any of the preceding clauses, further including a cold air line, wherein the steam line and the cold air line are fluidly connected to the premixing chamber.

The cyclonic separator system of any of the preceding clauses, further including a first throttle downstream of the steam line and the premixing chamber and a second throttle disposed downstream of cold air line.

The cyclonic separator system of any of the preceding clauses, further including a cold air line, wherein the air line and the cold air line are fluidly connected to the premixing chamber.

The cyclonic separator system of any of the preceding clauses, further including a first throttle downstream of the steam line and the mixing chamber and a second throttle disposed downstream of cold air line.

The cyclonic separator system of any of the preceding clauses, further including a throttle disposed between the steam line and the mixing chamber.

The cyclonic separator of any of the preceding clauses, wherein the mixing chamber includes a radial inlet and an axial inlet.

The cyclonic separator of any of the preceding clauses, wherein the steam line is fluidly connected to the radial inlet and the air line is fluidly connected to the axial inlet.

The cyclonic separator of any of the preceding clauses, wherein the air line is fluidly connected to the radial inlet and the steam line is fluidly connected to the axial inlet.

The cyclonic separator system of any of the preceding clauses, wherein the first outlet is disposed on a radial portion of the separation chamber, and the second outlet is disposed on an axial portion of the separation chamber.

The cyclonic separator system of any of the preceding clauses, further including a diffuser downstream of the mixing chamber and upstream of the swirler.

The cyclonic separator system of any of the preceding clauses, wherein a first flow through the first outlet includes more particulates than a second flow through the second outlet.

The cyclonic separator of any of the preceding clauses, further including a steam injector disposed between the steam line and the cyclonic separator.

A gas turbine engine including a steam source, an exhaust, a turbine including a turbine blade, and a cyclonic separator system including a steam line fluidly connected to the steam source, an air line, an exhaust line fluidly connected to the exhaust, and a cyclonic separator disposed upstream of the turbine, the cyclonic separator including a mixing chamber downstream of the steam line and the air line, a swirler downstream of the mixing chamber, and a separation chamber including a first outlet and a second outlet, wherein the first outlet of the separation chamber is fluidly connected to the exhaust line, and wherein the second outlet of the separation chamber is fluidly connected to the turbine.

The gas turbine engine of any of the preceding clauses, further including a cold air line, wherein the cyclonic separator further includes a premixing chamber upstream of the mixing chamber.

The gas turbine engine of any of the preceding clauses, wherein the steam line and the cold air line are fluidly connected to the premixing chamber.

The gas turbine engine of any of the preceding clauses, wherein the air line and the cold air line are fluidly connected to the premixing chamber.

The gas turbine engine of any of the preceding clauses, wherein the mixing chamber includes a radial inlet and an axial inlet.

The gas turbine engine of any of the preceding clauses, further including a throttle disposed between the steam line and the mixing chamber

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cyclonic separator system for a gas turbine engine, the cyclonic separator system comprising:
a steam line fluidly connected to a steam source;
an air line;
an exhaust line; and
a cyclonic separator fluidly connected to the steam line and the air line, the cyclonic separator comprising:
a mixing chamber disposed downstream of the steam line and the air line;
a swirler disposed downstream of the mixing chamber; and
a separation chamber disposed downstream of the swirler, the separation chamber including a first outlet and a second outlet,
wherein the first outlet of the separation chamber is fluidly connected to the exhaust line, and
wherein the second outlet of the separation chamber is fluidly connected to a component of the gas turbine engine.

2. The cyclonic separator system of claim 1, wherein the cyclonic separator further comprises a premixing chamber disposed upstream of the mixing chamber.

3. The cyclonic separator system of claim 2, further comprising a cold air line wherein the steam line and the cold air line are fluidly connected to the premixing chamber.

4. The cyclonic separator system of claim 3, further comprising a first throttle disposed downstream of the steam line and the premixing chamber and a second throttle disposed downstream of the cold air line.

5. The cyclonic separator system of claim 2, further comprising a cold air line, wherein the air line and the cold air line are fluidly connected to the premixing chamber.

6. The cyclonic separator system of claim 5, further comprising a first throttle disposed downstream of the steam line and the mixing chamber and a second throttle disposed downstream of the cold air line.

7. The cyclonic separator system of claim 1, further comprising a throttle disposed between the steam line and the mixing chamber.

8. The cyclonic separator of claim 1, wherein the mixing chamber includes a radial inlet and an axial inlet.

9. The cyclonic separator of claim 8, wherein the steam line is fluidly connected to the radial inlet and the air line is fluidly connected to the axial inlet.

10. The cyclonic separator of claim 8, wherein the air line is fluidly connected to the radial inlet and the steam line is fluidly connected to the axial inlet.

11. The cyclonic separator system of claim 1, wherein the first outlet is disposed on a radial portion of the separation chamber, and the second outlet is disposed on an axial portion of the separation chamber.

12. The cyclonic separator system of claim 1, further comprising a diffuser disposed downstream of the mixing chamber and upstream of the swirler.

13. The cyclonic separator system of claim 1, wherein a first flow through the first outlet includes more particulates than a second flow through the second outlet.

14. The cyclonic separator of claim 1, further comprising a steam injector disposed between the steam line and the cyclonic separator.

15. A gas turbine engine comprising:
a steam source;
an exhaust;
a turbine including a turbine blade; and
a cyclonic separator system comprising:
a steam line fluidly connected to the steam source;
an air line;
an exhaust line fluidly connected to the exhaust; and
a cyclonic separator disposed upstream of the turbine, the cyclonic separator comprising:
a mixing chamber disposed downstream of the steam line and the air line;
a swirler disposed downstream of the mixing chamber; and
a separation chamber including a first outlet and a second outlet,
wherein the first outlet of the separation chamber is fluidly connected to the exhaust line, and
wherein the second outlet of the separation chamber is fluidly connected to the turbine.

16. The gas turbine engine of claim 15, wherein the cyclonic separator further comprises a premixing chamber upstream of the mixing chamber.

17. The gas turbine engine of claim 16, further comprising a cold air line, wherein the steam line and the cold air line are fluidly connected to the premixing chamber.

18. The gas turbine engine of claim 16, further comprising a cold air line, wherein the air line and the cold air line are fluidly connected to the premixing chamber.

19. The gas turbine engine of claim 15, wherein the mixing chamber includes a radial inlet and an axial inlet.

20. The gas turbine engine of claim 15, further comprising a throttle disposed between the steam line and the mixing chamber.
